(19) United States
(12) Patent Application Publication
(10) Pub. No.: US 2009/0059854 A1
(43) Pub. Date: Mar. 5, 2009

(54) RADIO COMMUNICATION BASE STATION APPARATUS AND RADIO COMMUNICATION METHOD

(75) Inventors: Akihiko Nishio, Kanagawa (JP); Isamu Yoshii, Kanagawa (JP); Hidetoshi Suzuki, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSAUSHITA ELECTRIC INDUSTRIAL CO., LTD., OSAKA (JP)

(21) Appl. No.: 12/160,197

(22) PCT Filed: Jan. 12, 2007
(86) PCT No.: PCT/JP2007/050341

§ 371 Date: Jul. 7, 2008

(30) Foreign Application Priority Data
Jan. 13, 2006 (JP) 2006-006081

(51) Int. Cl. H04W 28/00

(52) U.S. Cl. 370/329

(57) ABSTRACT

Provided is a base station capable of searching cells of different frequencies without losing a chance of data communication by effectively performing SCH data communication. The base station (100) includes: an encoding unit (101) for encoding SCH data; a modulation unit (102) for modulating the encoded SCH data; encoding units (103-1 to 103-N) for encoding user data (#1 to #N), modulation units (104-1 to 104-N) for modulating the encoded user data (#1 to #N); a frame format setting unit (105) for setting a frame format of each frame; and an IFFT unit (106) for mapping the SCH data and the user data (#1 to #N) to sub carriers (#1 to #K) and performing IFFT to generate an OFDM symbol. The frame format setting unit (105) changes the data communication sub frame for each frame so as to change the position of the data communication section within a frame for each frame.

### TECHNICAL FIELD

The present invention relates to a radio communication base station apparatus and a radio communication method.

### BACKGROUND ART

In recent years, in radio communication, particularly in mobile communication, various kinds of information such as images and data as well as speech are subjected to transmission. From now on, it is expected that demands further increase for transmitting various types of content, and it naturally follows that the need for high speed transmission is expected to further increase. However, when high speed transmission is performed in mobile communication, the influence of delayed waves by multipath is not negligible, and transmission performance degrades due to frequency selective fading.

Multicarrier communication such as OFDM (Orthogonal Frequency Division Multiplexing) is focused as one of counter techniques of frequency selective fading. Multicarrier communication is a technique of performing high speed transmission by transmitting data using a plurality of carriers (subcarriers) of transmission rates suppressed to such an extent that frequency selective fading does not occur. Particularly, the OFDM scheme utilizes a plurality of subcarriers orthogonal to each other where data is arranged, provides high frequency efficiency in multicarrier communication, can be implemented with relatively simple hardware, is particularly focused and is variously studied.

At present, according to the LTE standardization of 3GPP, adopting the OFDM scheme as the downlink communication scheme is studied. With OFDM in the downlink, user data and control data for a plurality of radio communication mobile station apparatuses (hereinafter “mobile stations”) are frequency-domain-multiplexed or time-domain-multiplexed and transmitted from radio communication base station apparatuses (hereinafter “base stations”) to mobile stations.

As a method of transmitting control data in OFDM on downlink, it is suggested to transmit SCH (synchronization channel) data at fixed timing (e.g., the tail end of a frame) using a fixed bandwidth (e.g., 1.25 MHz) (see Non-Patent Document 1).

Here, the SCH is a common channel in the downlink direction and comprised of a P-SCH (primary synchronization channel) and an S-SCH (secondary synchronization channel). P-SCH data contains a sequence which is common in all cells and used for a timing synchronization upon a cell search. Further, S-SCH data contains cell-specific transmission parameters such as scrambling code information. In a cell search upon power activation and upon handover, each mobile station finds a timing synchronization by receiving P-SCH data and acquires transmission parameters that differ per cell by receiving S-SCH data. By this means, each mobile station can start communicating with base stations. Therefore, each mobile station needs to detect SCH data upon power activation and upon handover.

As described above, a mobile station needs to detect SCH data upon power activation, and, moreover, upon handover. In asynchronous mobile communication systems, the transmission timing for SCH data differs per base station (i.e., per cell), and, consequently, a mobile station needs to detect SCH data transmitted from a base station for handover to synchronize with the base station for handover.

Here, when the mobile station performs handover with base station BS2 having a different frequency band (hereinafter “band”) from the band for base station BS1 communicating with the mobile station, as shown in FIG. 1, a cell search is performed in the measurement gap (MG) set by base station BS1 to detect SCH data transmitted from base station BS2 for handover. Thus, a cell search performed in a different band from the band communicating with the mobile station is referred to as a “different-frequency cell search.” The measurement gap is a period in which data transmission stops between a base station and a mobile station, that is, the measurement gap is also referred to as a “non-transmission period.” The mobile station performs a different-frequency cell search in the measurement gap. Therefore, while user data is received from BS1, the mobile station needs to detect SCH data by switching reception frequency from the band for BS1 to the band for BS2, and, after that, restart receiving user data by switching the reception frequency from the band for BS2 to the band for BS1. This switching of reception frequency requires about one subframe of time, and, consequently, the detection time is also taken into consideration and the measurement gap is set over a period of three subframes.

A communication system where a frame is 10 ms and comprised of 20 subframes, will be assumed and explained below. Further, in the frame, SCH data is transmitted by one of subframes. Further, for example, above BS1 is a base station that is provided in the 800 MHz band of a macro cell and performs mobile communication, and above BS2 is a base station that is provided in the 2 GHz band or 2.6 GHz band of a micro cell set as a hot spot or the like in part of this macro cell and performs high speed communication.

Conventionally, a measurement gap is periodically set, that is, a measurement gap is set in a fixed manner in arbitrary subframes in a frame. For example, in FIG. 1, a measurement gap is set in a fixed manner in subframes #3 to #5 in all frames. Here, subframes in which a measurement gap is set may differ per mobile station.
Non-Patent Document 1: 3GPP RAN WG1 LTE Ad Hoc meeting (2005.06) R1-050590

### DISCLOSURE OF INVENTION

### Problems to be Solved by the Invention

However, when a measurement gap is set in a fixed manner as described above, if SCH data is transmitted at fixed timing as is conventionally done, a mobile station may fail to perform a different-frequency cell search in the measurement gap. For example, as shown in FIG. 2, although the measurement gap in BS1 is set in a fixed manner in subframes #3 to #5 in all frames, if SCH data is transmitted from BS2 in subframe #5 in all frames, a mobile station cannot detect the SCH data from BS2 in the measurement gap in all frames in BS1 and perform a different-frequency cell search.

To solve the above problem, as shown in FIGS. 3 to 5, the measurement gap of BS1 is assumed to be moved by one subframe every frame. For example, the measurement gap in frame #1 is set in subframes #2 to #4 (FIG. 3), the measurement gap in frame #2 is set in subframes #3 to #5 (FIG. 4) and the measurement gap in frame #5 is set in subframes #4 to #6 (FIG. 5). By this means, a mobile station can reliably detect SCH data per twenty frames at a maximum.

However, if the above method is employed, the following problems occur. That is, if the measurement gap is moved as above, a mobile station cannot perform data communication with subframe #4 in frames #1, #2 and #3 (FIGS. 3, 4 and 5).

Therefore, when the frame format in BS1 is fixed as shown in FIG. 6, a mobile station performing a different-frequency cell search loses the opportunity to receive MBMS (Multimedia Broadcast/Multicast Service) data, resulting in deteriorating MBMS service quality. MBMS communication is not one-to-one communication but is one-to-many communication, and, consequently, a base station that performs MBMS transmits a same data (such as music data and moving image data) to a plurality of mobile stations at the same time. As MBMS, for example, traffic information distribution, music distribution, news reporting and sports broadcast are studied. For example, in MBMS, as shown in FIG. 6, all mobile stations that communicate with BS1 receive the same MBMS data in subframe #4, and, consequently, even if the number of mobile stations that communicate with BS1 increases, subframes for MBMS data need not to be added. Therefore, the frame format shown in FIG. 6, in which only one subframe in a frame is used for MBMS data and the other nineteen subframes are used for dedicated data of each mobile station, needs to be studied sufficiently.

Further, if the frame format in BS1 is fixed as shown in FIG. 7 (DL: downlink data, UL: uplink data), a mobile station performing a different-frequency search loses the opportunity to transmit uplink data. Recently, for example, more and more music data and moving image data are downloaded to mobile stations, and, consequently, the frame format shown in FIG. 7, in which only one subframe in a frame is used on uplink and the other nineteen subframes are used on downlink, needs to be studied sufficiently. Here, during this downloading, a mobile station needs to transmit control data to BS1. As a result, if a mobile station loses the opportunity to transmit uplink data, the mobile station cannot even receive downlink data.

It is therefore an object of the present invention to provide a base station and radio communication method that solve the above problems and can perform radio communication efficiently.

### Means for Solving the Problem

The base station of the present invention employs a configuration having: a setting section that sets a frame format including a non-transmission period and a data communication period; and a transmitting section that transmits data according to the frame format, and in which the setting section changes the frame format over time.

### Advantageous Effect of the Invention

According to the present invention, it is possible to efficiently perform radio communication and perform a cell search without losing the opportunity to perform data communication.

### BRIEF DESCRIPTION OF DRAWINGS

FIG. 1 illustrates a conventional SCH data transmission method;

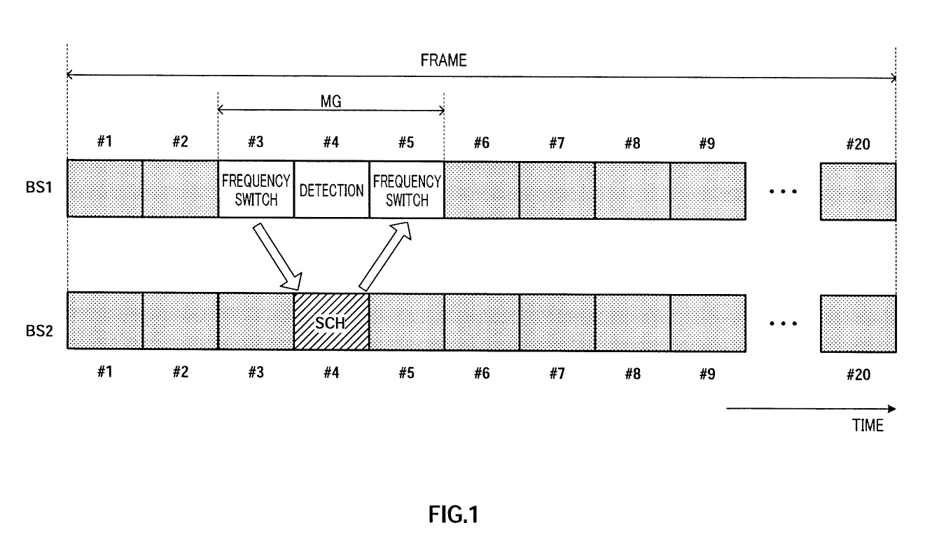

FIG. 2 illustrates an example of a problem with respect to the conventional SCH data transmission method;

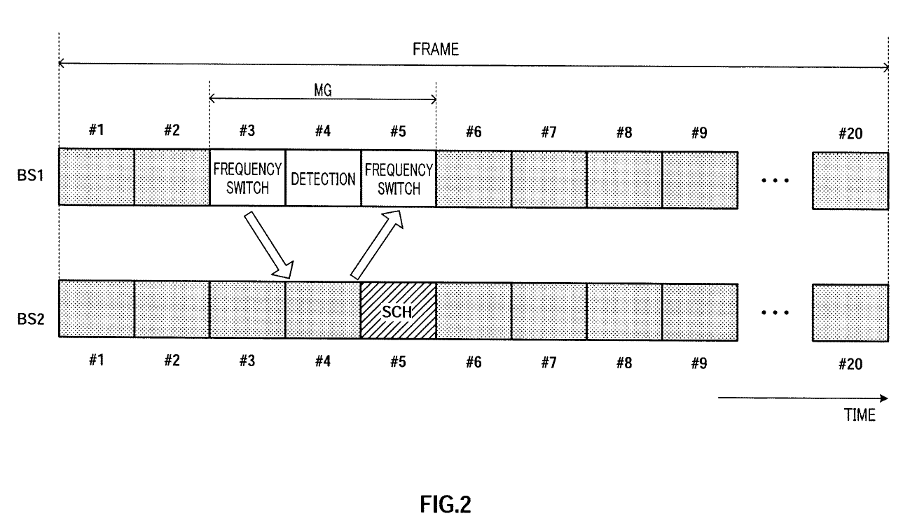

FIG. 3 illustrates an example of solving a problem with respect to a conventional SCH data transmission method (frame #1);

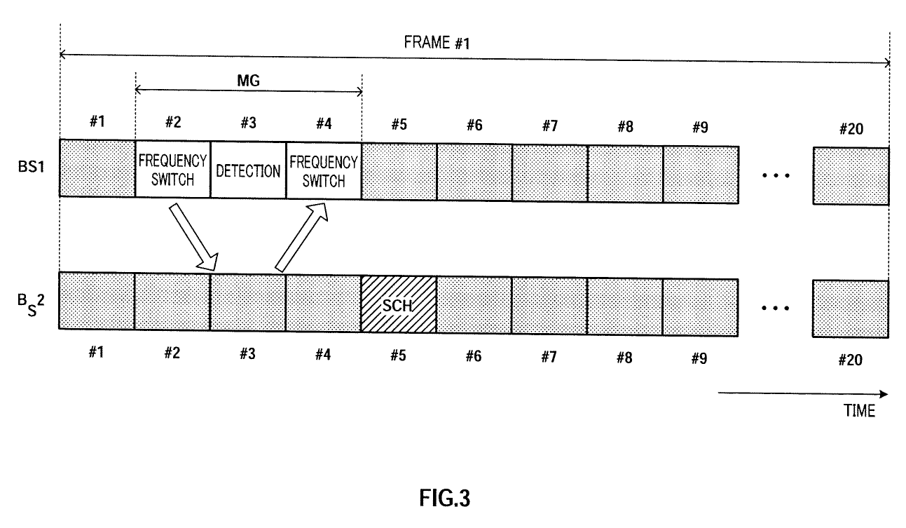

FIG. 4 illustrates an example of solving a problem with respect to a conventional SCH data transmission method (frame #2);

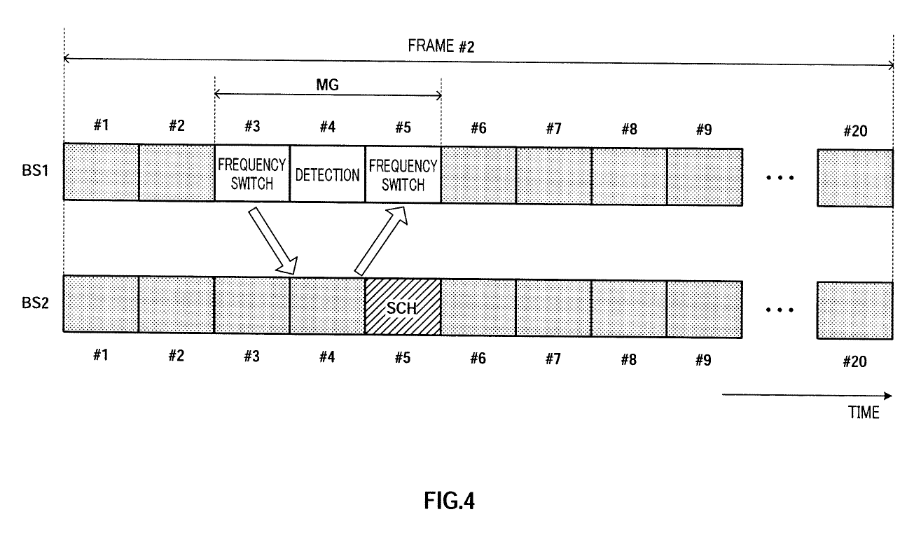

FIG. 5 illustrates an example of solving a problem with respect to a conventional SCH data transmission method (frame #3);

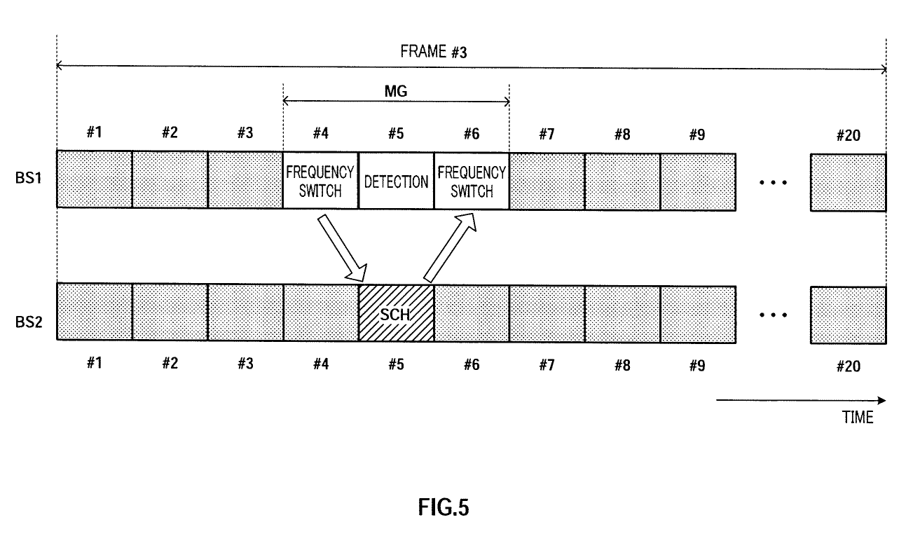

FIG. 6 illustrates an example of a conventional frame format (frame format example 1);

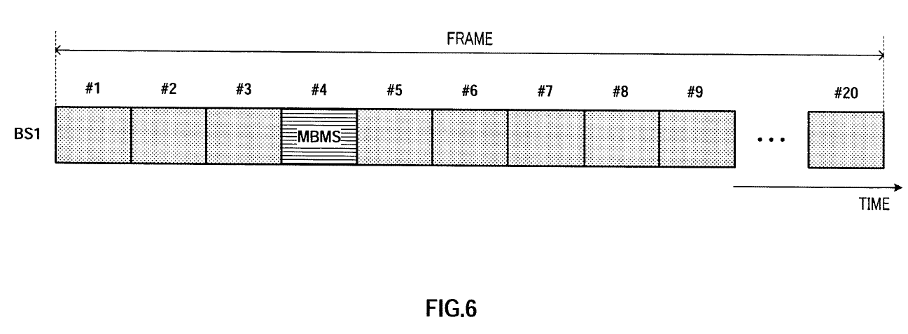

FIG. 7 illustrates an example of a conventional frame format (frame format example 2);

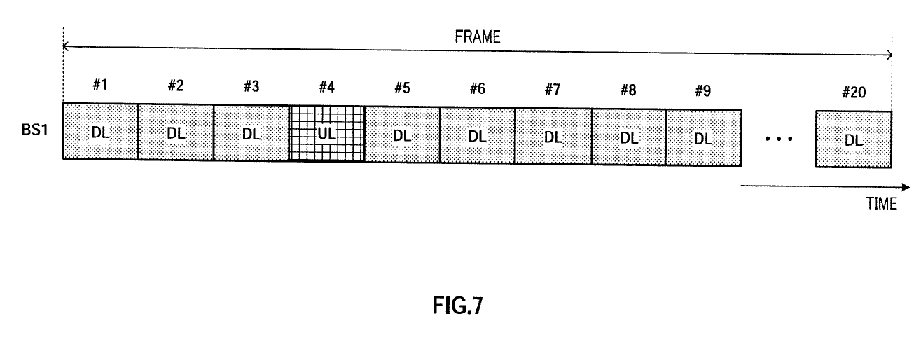

FIG. 8 is a block diagram showing a configuration of a base station according to an embodiment of the present invention;

FIG. 9 illustrates setting example 1 of a frame format according to an embodiment of the present invention (frame #1);

FIG. 10 illustrates setting example 1 of a frame format according to an embodiment of the present invention (frame #2);

FIG. 11 illustrates setting example 1 of a frame format according to an embodiment of the present invention (frame #3);

FIG. 12 illustrates setting example 2 of a frame format according to an embodiment of the present invention (frame #1);

FIG. 13 illustrates setting example 2 of a frame format according to an embodiment of the present invention (setting example #2); and

FIG. 14 illustrates setting example 2 of a frame format according to an embodiment of the present invention (frame #3);

### BEST MODE FOR CARRYING OUT THE INVENTION

An embodiment of the present invention will be explained below in detail with reference to the accompanying drawings. Here, the present invention relates to above BS1. That is, the present invention relates to a base station that performs data communication with a mobile station and sets the measurement gap in a base station. Further, although an OFDM scheme is explained as an example of a multicarrier communication scheme in the following explanation, the present invention is not limited to the OFDM scheme.

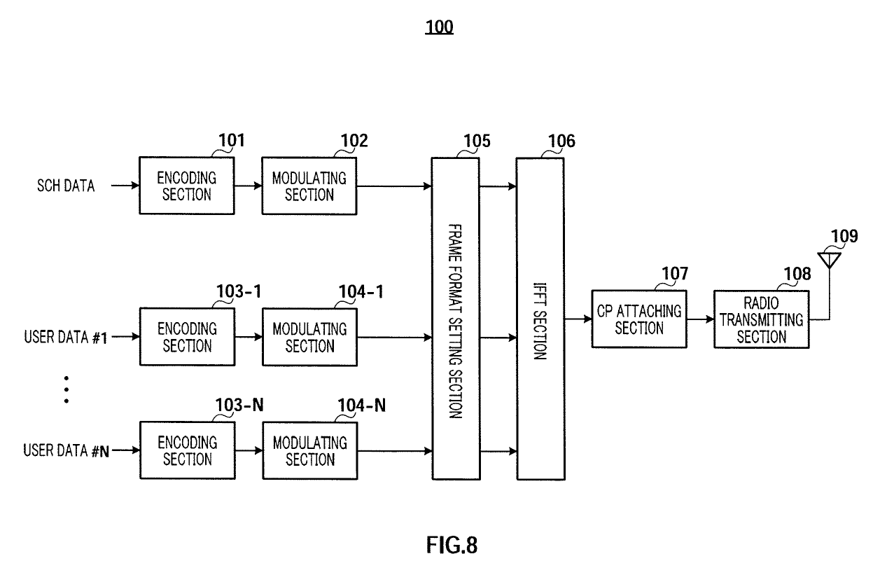

FIG. 8 illustrates a configuration of base station 100 according to the present embodiment.

Encoding section 101 encodes SCH data. This SCH data is comprised of P-SCH data and S-SCH data.

Modulating section 102 modulates the encoded SCH data.

Encoding sections 103-1 to 103-N and modulating sections 104-1 to 104-N are provided for mobile stations #1 to #N to which base station 100 transmits user data.

Encoding sections 103-1 to 103-N encode user data #1 to #N, respectively.

Modulating sections 104-1 to 104-N modulate the encoded user data #1 to #N, respectively.

Here, these user data contain MBMS data.

Frame format setting section 105 sets the frame format of each frame. This frame format setting will be described later in detail.

IFFT section 106 generates an OFDM symbol by mapping the SCH data and user data #1 to #N in subcarriers #1 to #K and performing an IFFT (Inverse Fast Fourier Transform).

The OFDM symbol generated as above is attached a cyclic prefix in CP attaching section 107, subjected to predetermined radio processing such as up-conversion in radio transmitting section 108 and transmitted by radio from antenna 109 to mobile stations #1 to #N.

Next, frame format setting will be explained in detail.

Frame format setting section 105 sets a frame format including a measurement gap (non-transmission period) and a data communication period. That is, frame format setting section 105 sets a plurality of subframes forming a frame, as the measurement gap and data communication subframes. Therefore, radio transmitting section 108 transmits data according to the frame format set in frame format setting section 105. Here, in the following explanation, as described above, assume that a frame is comprised of twenty subframes.

Setting examples 1 and 2 will be explained below. In setting examples 1 and 2, every frame, frame format setting section 105 changes the subframes for data transmission among subframes #1 to #20 to change the position of the data communication period in the frame. That is, frame format setting section 105 periodically changes the frame format over time.

Here, in setting examples 1 and 2, as is conventionally done as above, in BS2 that is a target for a different-frequency cell search, the subframe for SCH data is set in a fixed manner in only subframe #5 in all frames. Thus, the frame format of BS2 is fixed.

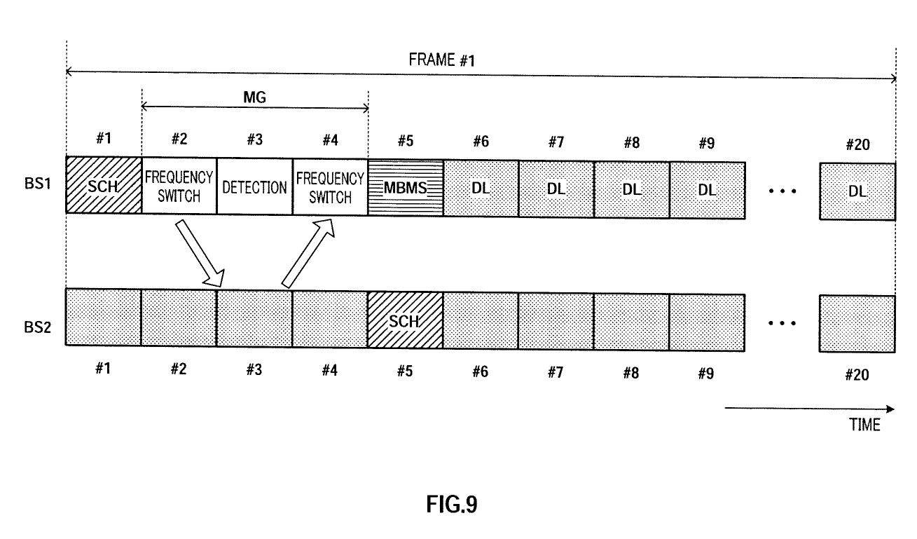

(Setting Example 1: FIGS. 9 to 11)

Frame format setting section 105 sets the frame format of frame #1 as shown in FIG. 9. In frame #1, frame format setting section 105 sets subframes #2 to #4 as a measurement gap and subframes #1 and #5 to #20 as a data communication period. Here, frame format setting section 105 sets subframe #1 in a fixed manner as the subframe for SCH data.

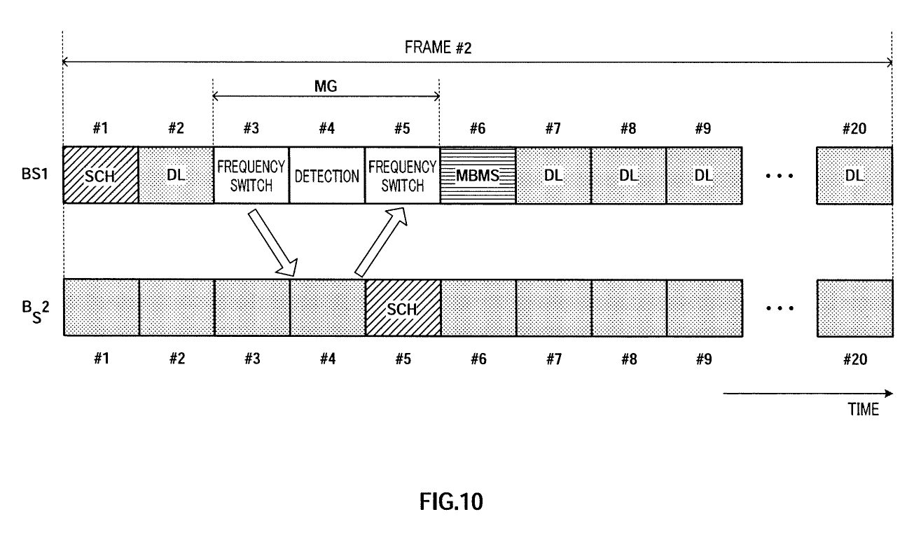

Next, frame format setting section 105 sets the frame format of frame #2 as shown in FIG. 10. In frame #2, frame format setting section 105 sets subframes #3 to #5 as the measurement gap and subframes #1, #2 and #6 to #20 as the data communication period.

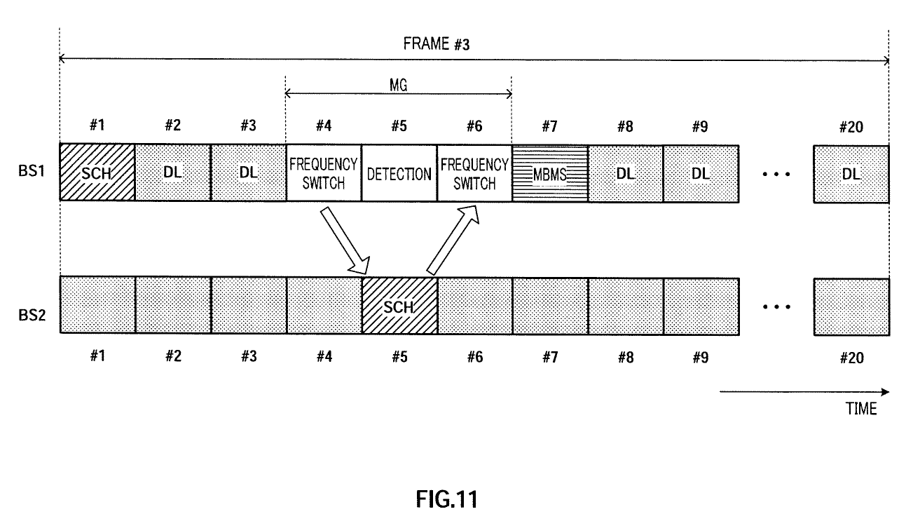

Next, frame format setting section 105 sets the frame format of frame #3 as shown in FIG. 11. In frame #3, frame format setting section 105 sets subframes #4 to #6 as the measurement gap and subframes #1 to #3 and #7 to #20 as the data communication period. Therefore, a mobile station can detect SCH data for BS2 in frame #3 and perform a different-frequency cell search.

That is, frame format setting section 105 moves the subframe, in which the measurement gap is set among subframes #2 to #20, by one subframe every frame. Further, frame format setting section 105 moves the subframe for data communication among subframes #2 to #20 by one subframe every frame, according to the relocation of the measurement gap. That is, frame format setting section 105 changes the position of the measurement gap in a frame over time and changes the position of the data communication period according to the change of the position of the measurement gap.

Thus, by changing the position of the measurement gap in a frame over time and changing the position of the data communication period according to the change of the measurement gap, the measurement gap moves to subframes #2 to #4 (in frame #1), subframes #3 to #5 (in frame #2) and subframes #4 to #6 (in frame #3), and subframes for MBMS data moves to subframe #5 (in frame #1), subframe #6 (in frame #2) and subframe #7 (in frame #3), so that it is possible to prevent the subframe for MBMS data from overlapping with the subframes of the measurement gap. Therefore, according to the present setting example, a mobile station can reliably detect SCH data from BS2 per twenty frames at a maximum and perform a different-frequency cell search without losing the opportunity to receive MBMS data.

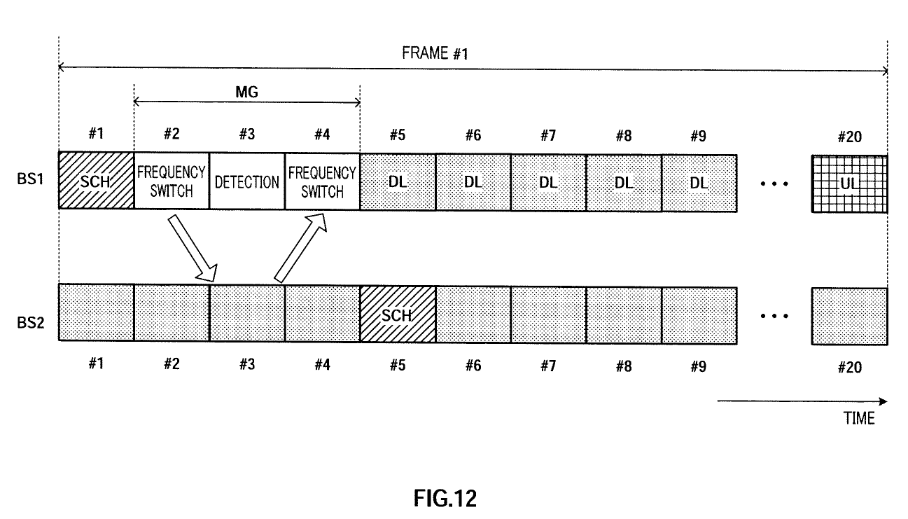

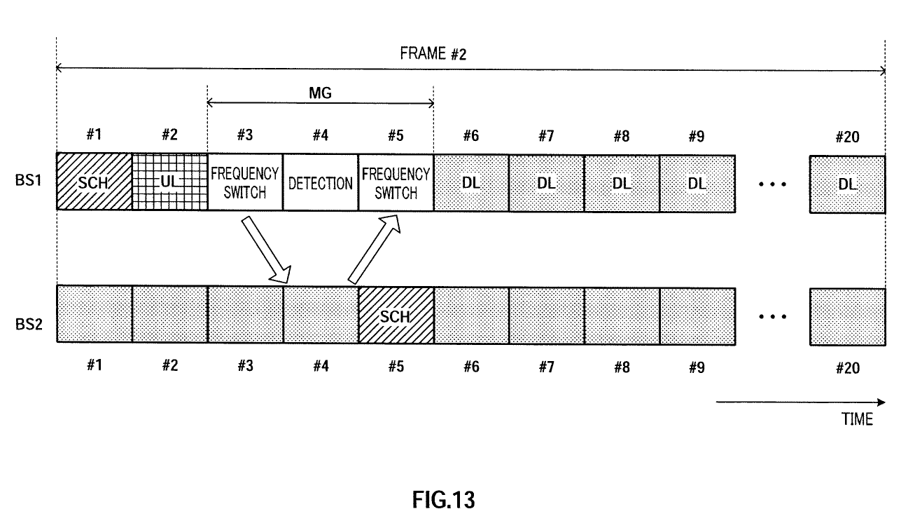

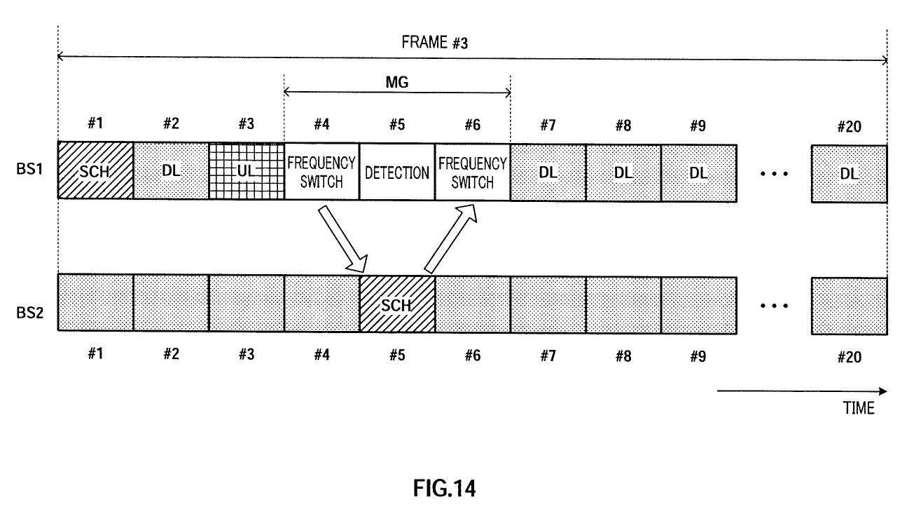

(Setting Example 2: FIGS. 12 to 14)

Setting of the measurement gap and setting of the data communication period is the same as above setting example 1. However, according to the present setting example, a measurement gap is set in a position other than the position immediately before the uplink data communication period. The examples shown in FIGS. 12 to 14 illustrate setting the subframe for uplink data in subframe #20 and the measurement gap in subframes #2 to #4 in frame #1, setting the subframe for uplink data in subframe #2 and the measurement gap in subframes #3 to #5 in frame #2, and setting the subframe for uplink data in subframe #3 and the measurement gap in subframes #4 to #6 in frame #3.

Thus, according to the present setting example, the measurement gap is not set immediately before the subframe for uplink data, so that it is possible to reliably set the subframe immediately before the subframe for uplink data, as the subframe for downlink data. Therefore, a mobile station can reliably receive downlink data immediately before uplink data transmission, and, consequently, accurately perform uplink open-loop control such as uplink transmitter diversity and uplink transmission power control.

As described above, according to the present embodiment, it is possible to perform radio communication efficiently.

An embodiment of the present invention has been described above.

Here, subframes in which the measurement gap is set may differ per mobile station. For example, as described above, in mobile station #1, the measurement gap is set in subframes #2 to #4 in frame #1, in subframes #3 to #5 in frame #2 and in subframes #4 to #6 in frame #3. On the other hand, in mobile station #2, the measurement gap is set in subframes #3 to #5 in frame #1, in #4 to #6 in frame #2 and in subframes #5 to #7 in frame #3.

Further, a base station may be referred to as “Node B,” a mobile station as “UE,” a subcarrier as a “tone,” a cyclic prefix as a “guard interval,” and a subframe as a “time slot” or simply “slot.”

Further, MBMS includes broadcast service and multicast service, and, consequently, is also referred to as “broadcast data” or “multicast data.” While the broadcast service is a service of transmitting information to all mobile stations like current radio broadcasting, the multicast service is a service of transmitting information only specified mobile stations that subscribe services such as newsgroup.

Although a case has been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-006081, filed on Jan. 13, 2006, including the specification, drawings and abstract, is incorporated herein by reference in its entirety.

### INDUSTRIAL APPLICABILITY

The present invention is suitable to, for example, a base station used in a mobile communication system.

1. A radio communication base station apparatus comprising:
a setting section that sets a frame format including a non-transmission period and a data communication period; and
a transmitting section that transmits data according to the frame format,
wherein the setting section changes the frame format over time.

2. The radio communication base station apparatus according to claim 1, wherein the setting section changes a position of the data communication period in a frame over time.

3. The radio communication base station apparatus according to claim 2, wherein the setting section changes a position of the non-transmission period in a frame over time and changes the position of the data communication period according to the change of the position of the non-transmission period.

4. The radio communication base station apparatus according to claim 1, wherein the setting section sets the non-transmission period in a position other than a position immediately before an uplink data communication period in a frame.

5. The radio communication base station apparatus according to claim 1, wherein the setting section periodically changes the frame format.

6. The radio communication base station apparatus according to claim 1, wherein the setting section changes the frame format every frame.

7. A radio communication method that sets a frame format including a non-transmission period and a data communication per iod, and that transmits data according to the frame format, the radio communication method comprising changing the frame format over time.
